(19) United States
(12) Patent Application Publication
(10) Pub. No.: US 2024/0383728 A1
(43) Pub. Date: Nov. 21, 2024

(54) INFLATABLE LIFT DEVICE

(71) Applicant: GM GLOBAL TECHNOLOGY OPERATIONS LLC, Detroit, MI (US)

(72) Inventors: Victor WONG, Lake Orion, MI (US); Jesus Anthony BERNAL, Farmington Hills, MI (US); Juan Orlando ESPANA MEDINA, Windsor (CA); Paul W. ALEXANDER, Ypsilanti, MI (US)

(21) Appl. No.: 18/319,798

(22) Filed: May 18, 2023

(51) Int. Cl. B66F 3/35

(52) U.S. Cl. CPC B66F 3/35

(57) ABSTRACT

An inflatable lift system for a vehicle includes N bladders arranged vertically in a stack, where N is an integer greater than two. N pressure sensors are configured to sense pressure in the N bladders, respectively. A compressor is configured to supply pressurized gas. N valves are configured to selectively connect and disconnect the N bladders to the compressor. A controller is configured to control the N valves to inflate the N bladders sequentially in a first predetermined order and to deflate the N bladders sequentially in reverse.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to lift devices for vehicles, and more particularly to inflatable lift devices.

A jack such as a scissor, bottle, or pneumatic jack may be used lift a heavy object such as a vehicle. For example, the vehicle may need to be raised when the vehicle has a flat tire that needs to be changed, for accessibility, or when other work needs to be done on the vehicle. The jacks tend to be heavy and may require significant physical effort when raising the vehicle. The jacks may not be sufficiently stable when lifting the vehicle on rougher surfaces that are not completely flat.

### SUMMARY

An inflatable lift system for a vehicle includes N bladders arranged vertically in a stack, where N is an integer greater than two. N pressure sensors are configured to sense pressure in the N bladders, respectively. A compressor is configured to supply pressurized gas. N valves are configured to selectively connect and disconnect the N bladders to the compressor. A controller is configured to control the N valves to inflate the N bladders sequentially in a first predetermined order and to deflate the N bladders sequentially in reverse.

In other features, the first predetermined order comprises a bottommost one of the N bladders sequentially to a topmost one of the N bladders. A bottommost one of the N bladders is arranged adjacent to a lift surface, and the bottommost one of the N bladders includes an upper planar surface and a flexible material including sides connected to the upper planar surface and a bottom surface extending between the sides of the flexible material.

In other features, a topmost one of the B bladders includes an upper planar surface, a lower planar surface, a bellows connecting sides of the upper planar surface to the lower planar surface, and non-fixed tendons connecting the upper planar surface to the lower planar surface.

In other features, one or more middle ones of the B bladders include an upper planar surface, a lower planar surface, a flexible material connecting sides of the upper planar surface to the lower planar surface, and fixed tendons connecting the upper planar surface to the lower planar surface.

In other features, one or more middle ones of the B bladders include an upper planar surface, a lower planar surface, a bellows connecting sides of the upper planar surface to the lower planar surface, and fixed tendons connecting the upper planar surface to the lower planar surface.

In other features, the N bladders are made of one or more materials selected from a group consisting of metal, rubber, and plastic.

An inflatable lift system for a vehicle includes N bladders arranged vertically in a stack, where N is an integer greater than two. A bottommost one of the N bladders includes an upper planar surface and a flexible material including sides connected to the upper planar surface and a bottom surface connecting sides of the flexible material. A topmost one of the N bladders includes an upper planar surface, a lower planar surface, bellows connecting sides of the upper planar surface to the lower planar surface, and non-fixed tendons connecting the upper planar surface to the lower planar surface. One or more middle ones of the N bladders include an upper planar surface, a lower planar surface, a flexible material connecting sides of the upper planar surface to the lower planar surface, and fixed tendons connecting the upper planar surface to the lower planar surface.

In other features, the N bladders are made of one or more materials selected from a group consisting of metal, rubber, and plastic. N pressure sensors are configured to sense pressure in the N bladders, respectively.

In other features, a compressor is configured to supply pressurized gas. N valves are configured to selectively connect and disconnect the N bladders to the compressor. A controller is configured to control the N valves to inflate the N bladders sequentially in a first predetermined order and to deflate the N bladders sequentially in reverse. The first predetermined order comprises a bottommost one of the N bladders sequentially to a topmost one of the N bladders.

An inflatable lift system for a vehicle includes N bladders arranged vertically in a stack, where N is an integer greater than two. A bottommost one of the N bladders includes an upper planar surface and a flexible material including sides connected to the upper planar surface and a bottom surface extending between the sides of the flexible material. A topmost one of the N bladders includes an upper planar surface, a lower planar surface, a bellows connecting sides of the upper planar surface to the lower planar surface, and non-fixed tendons connecting the upper planar surface to the lower planar surface. One or more middle ones of the N bladders include an upper planar surface, a lower planar surface, a bellows connecting sides of the upper planar surface to the lower planar surface, and fixed tendons connecting the upper planar surface to the lower planar surface.

In other features, the N bladders are made of one or more materials selected from a group consisting of metal, rubber, and plastic. N pressure sensors are configured to sense pressure in the N bladders, respectively.

In other features, a compressor configured to supply pressurized gas. N valves are configured to selectively connect and disconnect the N bladders to the compressor. A controller is configured to control the N valves to inflate the N bladders sequentially in a first predetermined order and to deflate the N bladders sequentially in reverse. The first predetermined order comprises a bottommost one of the N bladders sequentially to a topmost one of the N bladders.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A, 1B and 1C are side cross sectional views of an example of an inflatable lift device according to the present disclosure;

FIGS. 2A and 2B are side cross sectional views of an example of an inflatable lift device according to the present disclosure;

FIGS. 3A and 3B are functional block diagrams of an example of a control system for an inflatable lift device according to the present disclosure; and

FIGS. 4A and 4B are flowcharts of examples of methods for operating the inflatable lift device according to the present disclosure.

In the drawings, reference numbers may be reused to identify similar and/or identical elements.

### DETAILED DESCRIPTION

While the inflatable lift device according to the present disclosure is described below in an example application for lifting vehicles, the inflatable lift device can be used in other applications for lifting other types of heavy objects.

Existing inflatable lift devices are increasing in size due to increasing vehicle weight. These inflatable lift devices are large, heavy and difficult to stow and/or transport. These inflatable lift devices typically include a single air bladder or bladders with multiple chambers that are connected together and inflate at the same time. In some examples, the inflatable lift device according to the present disclosure includes multiple bladders that are inflated in a predetermined order to provide a controlled lifting motion. In some examples, the predetermined order is sequentially from a bottommost bladder to a topmost bladder. In other examples, other sequences such as topmost to bottommost bladder may be used such as when the inflatable lifting device is connected to a bottom surface of the heavy object. In other examples, non-sequential inflation such as middle, bottommost, and then topmost can be used.

In some examples, some of the bladders of the inflatable lift device are designed to perform different tasks during lifting. In some examples, the inflatable lift device includes a bottommost bladder is configured to contour around ground surface imperfections. Traditional scissor, bottle jack, and/or pneumatic lifts typically have a metal base that is sensitive to uneven surfaces. In some examples, one or more bladders of the inflatable lift device have non-fixed internal tendons that cause an upper planar surface of the bladder to tilt and conform to a bottom surface of an object as the object is lifted. In some examples, other bladders of the inflatable lift device have fixed tendons that force the bladder to inflate in a fixed or predetermined orientation (e.g., parallel to ground).

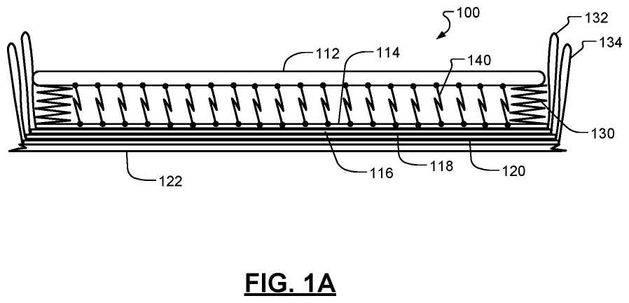

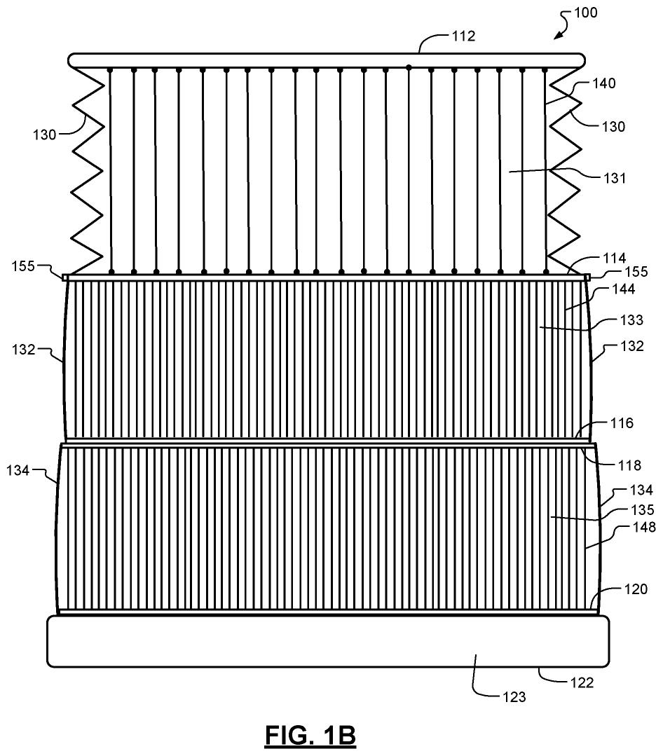

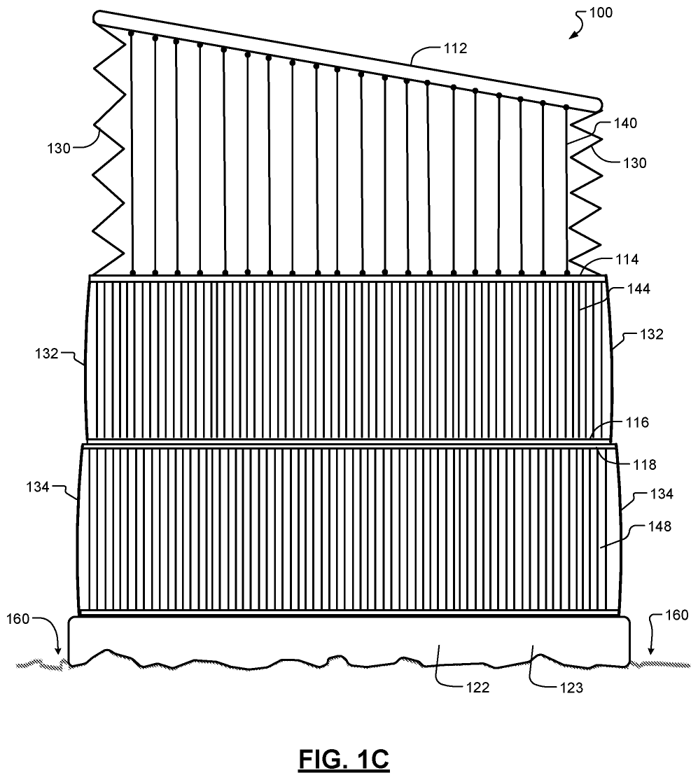

Referring now to FIGS. 1A to 1C, an example of an inflatable lift device according to the present disclosure includes a plurality of bladders that are arranged in a vertical stack. In some examples, the inflatable lift device includes at least three bladders including a bottommost bladder that does not include tendons and conforms to a lifting surface, one or more middle bladders including fixed tendons, and a topmost bladder that includes non-fixed tendons to allow the topmost bladder to tilt and conform to a facing surface of the heavy object to be lifted.

In FIG. 1A, the inflatable lift device 100 includes planar surfaces 112, 114, 116, 118, and 120. Sides of the planar surface 112 and the planar surface 114 are connected by a bellows 130 to form a bladder 131. Sides of the planar surface 114 and the planar surface 116 are connected by a flexible material 132 to form a bladder 133. The planar surface 116 is attached to the planar surface 118. Sides of the planar surface 118 and the planar surface 120 are connected by a flexible material 134 to form a bladder 135. A flexible material 122 defines a bottom surface and sides of a bladder 123. The sides of the flexible material 122 are connected to the planar surface 120.

In some examples, pairs of the planar surfaces forming upper and/or lower surfaces of the bladders are attached by fixed tendons. The fixed tendons are fixedly attached to facing surfaces of adjacent pairs of planar surfaces. In some examples, the tendons ensure that the planar surfaces of the bladders are parallel to one another and the ground when fully inflated.

In some examples, pairs of the planar surfaces forming upper and/or lower surfaces of the bladders are attached by non-fixed tendons. Non-fixed tendons allow the tendons to move at some or all of the mounting locations to the planar surfaces to allow tilting. In some examples, facing surfaces of the planar surface 112 and the planar surface 114 are connected by tendons 140 that are non-fixed to allow tilting of the planar surface 112 relative to the ground in one or more directions during lifting. In some examples, facing surfaces of the planar surface 114 and the planar surface 116 are connected by tendons 144 that are fixed. In some examples, facing surfaces of the planar surface 118 and the planar surface 120 are connected by tendons 148 that are fixed. In some examples, the bladder 123 does not include tendons to accommodate a variable ground/lift surface. Additional details relating to inflatable devices with tendons can be found in commonly assigned U.S. Pat. No. 11,084,541, entitled “Internally Tensioned Inflatable Structures”, issued on Aug. 10, 2021, which is hereby incorporated herein in its entirety.

The inflatable lift device 100 is shown in a deflated position in FIG. 1A and in different inflated positions in FIGS. 1B and 1C. In FIG. 1B, the planar surface 112 is parallel to the ground when fully inflated. In FIG. 1C, the bladder 123 is initially filled and is able to accommodate variable ground/lift surfaces 160 once lifting is initiated. A bottom surface of the bladder 123 conforms to the ground/lift surfaces 160.

After inflating the bladder 123, the bladder 135 is inflated. The tendons 148 are fixed and have a fixed length such that the planar surface 120 is parallel to the planar surface 118 when the bladder 135 is fully inflated. After inflating the bladder 135, the bladder 133 is inflated. The tendons 144 are fixed and have a fixed length such that the planar surface 116 is parallel to the planar surface 114 when the bladder 133 is fully inflated.

After inflating the bladder 133, the bladder 131 is inflated. The tendons 144 are not fixed such that the planar surface 112 can tilt and conform to a surface of the object to be lifted (e.g., a vehicle or other object). In other words, the planar surface 112 can be parallel to the planar surface 114 (as shown in FIG. 1B) or form an angle relative to the planar surface 114 (as shown in FIG. 1C) depending on the orientation of a surface of the object facing the inflatable lift device 100.

In some examples, the planar surfaces 112, 114, 116, 118 and 120 are made of metal, rubber, plastic, or another material. In some examples, the flexible material 132, 134, and 122 and the bellows 130 comprises rubber. In some examples, a metal ring 155 (FIG. 1B) is used to attach the flexible material to a planar surface.

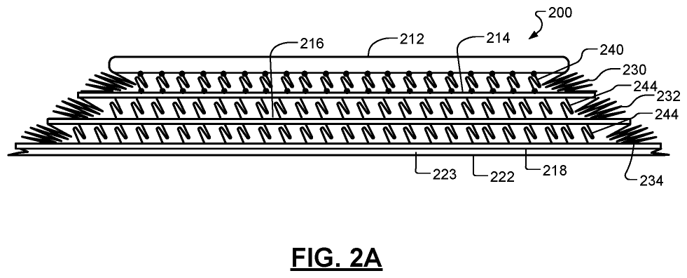

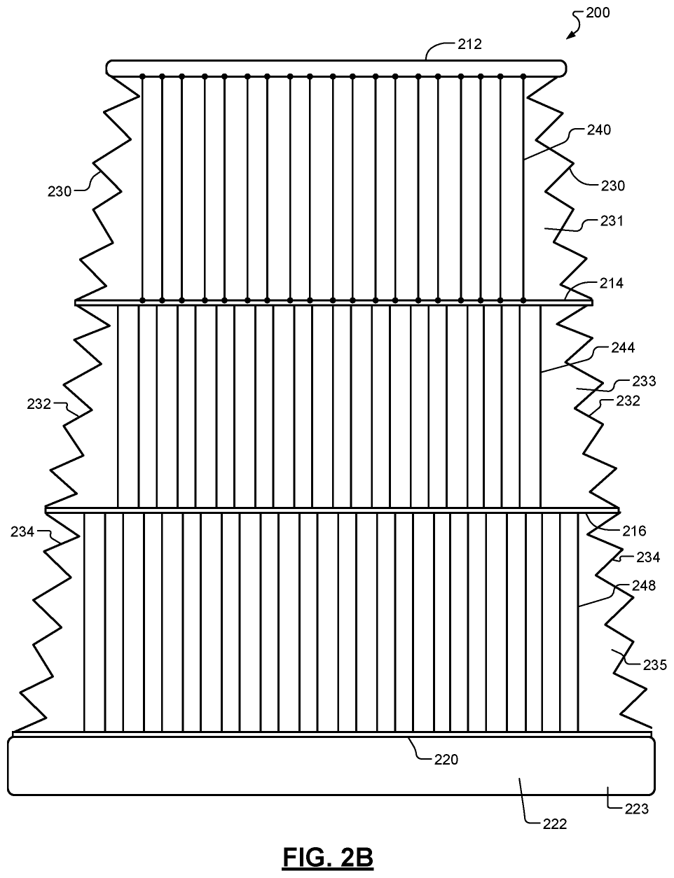

Referring now to FIGS. 2A and 2B, an inflatable lift device 200 includes one or more planar surfaces 212, 214, 216, and 220. Sides of the planar surface 212 and the planar surface 214 are connected by a bellows 230 to form a bladder 231. Sides of the planar surface 214 and the planar surface 216 are connected by a bellows 232 to form a bladder 233. Sides of the planar surface 216 and the planar surface 220 are connected by a bellows 234 to form a bladder 235. A bladder 223 is connected to the planar surface 220.

In some examples, the planar surfaces are attached by fixed tendons or non-fixed tendons. Facing surfaces of the planar surface 212 and the planar surface 214 are connected by tendons 240 that are not fixed (to accommodate tilting of the planar surface 212 during lifting). Facing surfaces of the planar surface 214 and the planar surface 216 are connected by tendons 244 that are fixed. Facing surfaces of the planar surface 216 and the planar surface 218 are connected by tendons 248 that are fixed. A flexible material 222 defines a bottom surface and sides of a bladder 223. The sides of the flexible material 222 are connected to the planar surface 220.

The inflatable lift device 200 is shown in a deflated position in FIG. 2A and in an inflated position in FIG. 2B. In FIG. 2B, the bladder 223 is initially filled and is able to accommodate variable ground/lift surfaces. A bottom surface of the bladder 223 conforms to the ground/lift surfaces. After inflating the bladder 223, the bladder 235 is inflated. The tendons 248 are fixed and have a fixed length such that the planar surface 220 is parallel to the planar surface 216 when fully inflated. After inflating the bladder 235, the bladder 233 is inflated. The tendons 244 are fixed and have a fixed length such that the planar surface 216 is parallel to the planar surface 214 when fully inflated. After inflating the bladder 233, the bladder 231 is inflated. The tendons 244 are non-fixed such that the planar surface 212 can tilt and conform to a facing surface of the object to be lifted (e.g., a bottom surface of a vehicle or other heavy object). In other words, the planar surface 212 can be parallel to the planar surface 214 or form an angle relative to the planar surface 214.

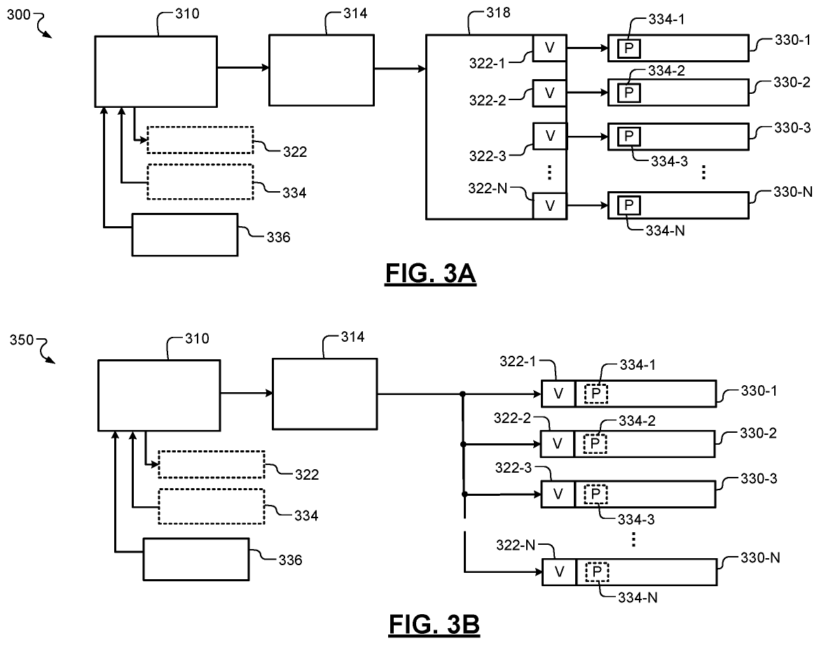

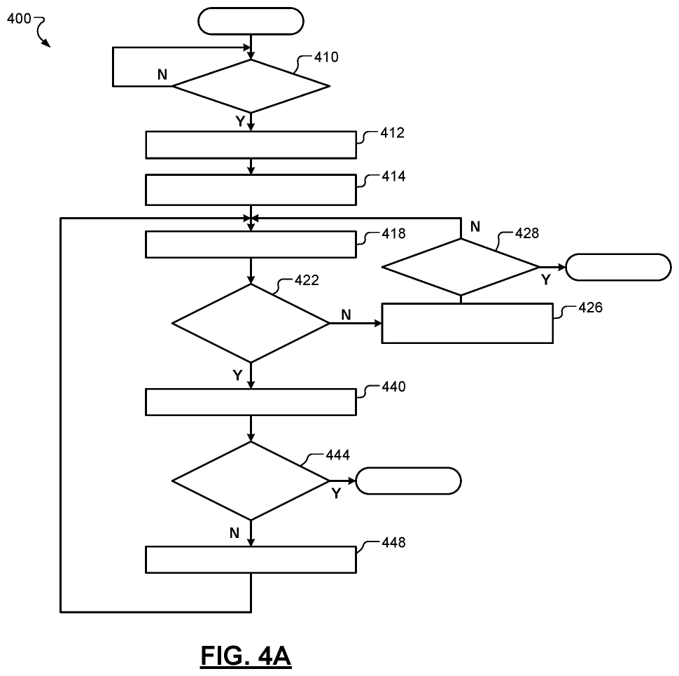

Referring now to FIGS. 3A and 3B, examples of control systems for the inflatable lift device is shown. In FIG. 3A, the control system 300 includes a controller 310 and a compressor 314 that supplies compressed gas such as air. A manifold 316 is connected to an output of the compressor 314 and includes N valves 322-1, 322-2, . . . , and 322-N corresponding to N bladders 330-1, 330-2, . . . , and 330-N. N pressure sensors 334-1, 334-2, . . . , and 334-N are arranged in the N bladders 330-1, 330-2, . . . , and 330-N to sense pressure within the N bladders 330-1, 330-2, . . . , and 330-N. The controller 310 receives outputs from the N pressure sensors 334-1, 334-2, . . . , and 334-N and is configured to control the N valves 322-1, 322-2, . . . , and 322-N to inflate and deflate the N bladders 330-1, 330-2, . . . , and 330-N in response to the sensed pressures as will be described further below. An input device 336 includes one or more controls such as buttons or a touch screen to allow the inflatable lift device to be controlled. In other examples, the compressor includes internal valves controlling outputs to each of the bladders. In some examples, the valves include three positions including open, closed, and vent to atmosphere. Alternately, another set of valves can be used to vent the gas to atmosphere when deflating the bladders.

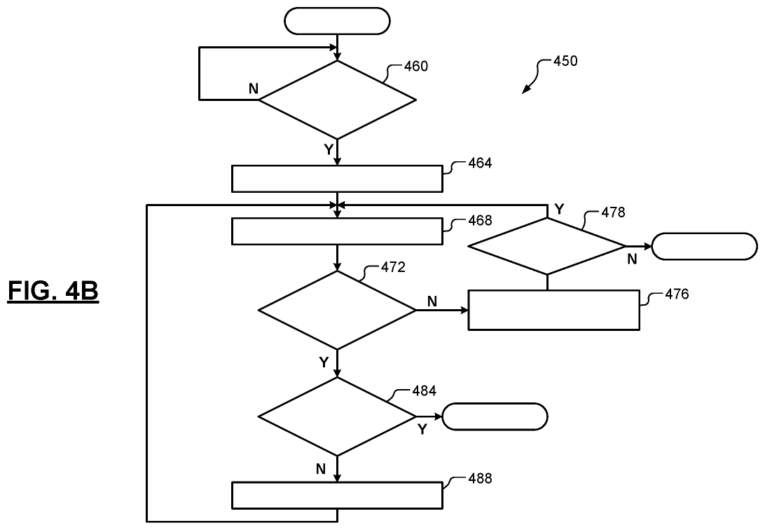

In FIG. 4A, the control system 350 includes the controller 310 and a compressor 314. The compressor 314 is connected to the N valves 322-1, 322-2, . . . , and 322-N corresponding to the N bladders 330-1, 330-2, . . . , and 330-N. The N pressure sensors 334-1, 334-2, . . . , and 334-N are arranged in the N bladders 330-1, 330-2, . . . , and 330-N to sense pressure within the N bladders 330-1, 330-2, . . . , and 330-N. The controller 310 receives outputs from the N pressure sensors 334-1, 334-2, . . . , and 334-N and is configured to control the N valves 322-1, 322-2, . . . , and 322-N to inflate and deflate the N bladders 330-1, 330-2, . . . , and 330-N in response to the sensed pressures as will be described further below.

Referring now to FIGS. 4A and 4B, flowcharts of methods for operating the inflatable lift device are shown. In FIG. 4A, a method 400 for inflating the inflatable lift device is shown. When an inflate button of the input device is actuated as determined at 410, N is set equal to the number of bladders at 412 and the compressor is actuated at 414. At 418, a valve for the bladder N (e.g., the bladder 123) is opened and the pressure P_{N} in the bladder 123 is measured. If the pressure P_{N} in the bladder N is less than a predetermined pressure as determined at 422, the method continues to inflate the bladder at 426. At 428, the method determines if the inflate button is still on. If 428 is true, the method returns to 418. If the inflate button is off at 428, the method ends and the inflatable lift device is partially inflated.

When the pressure in the bladder 123 is greater than or equal to a predetermined pressure as determined at 422, the method closes the valve for the bladder N. If N is not equal to M at 444, the method decrements N and returns to 418. If all of the bladders are to be inflated, M=1. However, M can be set to 2, 3, . . . , N−1 corresponding inflation of fewer bladders. For example when M=1, the uppermost bladder is inflated. When M=2, the uppermost bladder is not inflated. The process repeats for each of the bladders until N−M+1 bladders are filled and the inflatable lift device is fully inflated. If N=M at 444, the method ends.

In FIG. 4B, a method 450 for deflating the inflatable lift device is shown. When a deflate button of the input device is actuated as determined at 460, T is set equal to 1 at 464. At 468, a valve for the bladder T (e.g., the bladder 131) is opened and the pressure in the bladder 131 is measured. If the pressure in the bladder is greater than a predetermined pressure as determined at 422, the method continues to deflate the bladder at 476. The method determines if the deflate button remains on at 478. If the deflate button is off at 478, the method ends and the inflatable lift device is partially deflated.

If the pressure in the bladder is less than or equal to a predetermined pressure as determined at 472, the method determines whether T=P (where N is the number of bladders and P<=N). For example, P=N for the case where all of the bladders are deflated. If 484 is false, the method continues with 488 and sets T=T+1. The process repeats for the next bladder. If T=P at 484, the method ends.

The inflatable lifting device uses pneumatic air bladders with tendons to lift heavy objects such as a vehicle. The compact and lightweight inflatable lifting device enables higher lift loads and requires smaller packaging space while stowed. As compared to traditional vehicle lift technologies, the inflatable lifting device also weighs less.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An inflatable lift system for a vehicle, comprising:
N bladders arranged vertically in a stack, where N is an integer greater than two;
N pressure sensors configured to sense pressure in the N bladders, respectively;
a compressor configured to supply pressurized gas;
N valves configured to selectively connect and disconnect the N bladders to the compressor; and
a controller configured to control the N valves to inflate the N bladders sequentially in a first predetermined order and to deflate the N bladders sequentially in reverse.

2. The inflatable lift system of claim 1, wherein the first predetermined order comprises a bottommost one of the N bladders sequentially to a topmost one of the N bladders.

3. The inflatable lift system of claim 1, wherein:
a bottommost one of the N bladders is arranged adjacent to a lift surface, and
the bottommost one of the N bladders includes an upper planar surface and a flexible material including sides connected to the upper planar surface and a bottom surface extending between the sides of the flexible material.

4. The inflatable lift system of claim 1, wherein a topmost one of the B bladders includes:
an upper planar surface;
a lower planar surface;
a bellows connecting sides of the upper planar surface to the lower planar surface; and
non-fixed tendons connecting the upper planar surface to the lower planar surface.

5. The inflatable lift system of claim 1, wherein one or more middle ones of the B bladders include:
an upper planar surface;
a lower planar surface;
a flexible material connecting sides of the upper planar surface to the lower planar surface; and
fixed tendons connecting the upper planar surface to the lower planar surface.

6. The inflatable lift system of claim 1, wherein one or more middle ones of the B bladders include:
an upper planar surface;
a lower planar surface;
a bellows connecting sides of the upper planar surface to the lower planar surface; and
fixed tendons connecting the upper planar surface to the lower planar surface.

7. The inflatable lift system of claim 1, wherein the N bladders are made of one or more materials selected from a group consisting of metal, rubber, and plastic.

8. An inflatable lift system for a vehicle, comprising:
N bladders arranged vertically in a stack, where N is an integer greater than two;
a bottommost one of the N bladders includes an upper planar surface and a flexible material including sides connected to the upper planar surface and a bottom surface connecting sides of the flexible material;
a topmost one of the N bladders includes an upper planar surface, a lower planar surface, bellows connecting sides of the upper planar surface to the lower planar surface, and non-fixed tendons connecting the upper planar surface to the lower planar surface; and
one or more middle ones of the N bladders include an upper planar surface, a lower planar surface, a flexible material connecting sides of the upper planar surface to the lower planar surface, and fixed tendons connecting the upper planar surface to the lower planar surface.

9. The inflatable lift system of claim 8, wherein the N bladders are made of one or more materials selected from a group consisting of metal, rubber, and plastic.

10. The inflatable lift system of claim 8, further comprising N pressure sensors configured to sense pressure in the N bladders, respectively.

11. The inflatable lift system of claim 10, further comprising:
a compressor configured to supply pressurized gas; and
N valves configured to selectively connect and disconnect the N bladders to the compressor.

12. The inflatable lift system of claim 11, further comprising a controller configured to control the N valves to inflate the N bladders sequentially in a first predetermined order and to deflate the N bladders sequentially in reverse.

13. The inflatable lift system of claim 12, wherein the first predetermined order comprises a bottommost one of the N bladders sequentially to a topmost one of the N bladders.

14. An inflatable lift system for a vehicle, comprising:
N bladders arranged vertically in a stack, where N is an integer greater than two;
a bottommost one of the N bladders includes an upper planar surface and a flexible material including sides connected to the upper planar surface and a bottom surface extending between the sides of the flexible material;
a topmost one of the N bladders includes an upper planar surface, a lower planar surface, a bellows connecting sides of the upper planar surface to the lower planar surface, and non-fixed tendons connecting the upper planar surface to the lower planar surface; and
one or more middle ones of the N bladders include an upper planar surface, a lower planar surface, a bellows connecting sides of the upper planar surface to the lower planar surface, and fixed tendons connecting the upper planar surface to the lower planar surface.

15. The inflatable lift system of claim 14, wherein the N bladders are made of one or more materials selected from a group consisting of metal, rubber, and plastic.

16. The inflatable lift system of claim 14, further comprising N pressure sensors configured to sense pressure in the N bladders, respectively.

17. The inflatable lift system of claim 16, further comprising:
a compressor configured to supply pressurized gas; and
N valves configured to selectively connect and disconnect the N bladders to the compressor.

18. The inflatable lift system of claim 17, further comprising a controller configured to control the N valves to inflate the N bladders sequentially in a first predetermined order and to deflate the N bladders sequentially in reverse.

19. The inflatable lift system of claim 18, wherein the first predetermined order comprises a bottommost one of the N bladders sequentially to a topmost one of the N bladders.
